(19) United States
(12) Patent Application Publication
(10) Pub. No.: US 2008/0023871 A1
(43) Pub. Date: Jan. 31, 2008

(54) METHODS OF FORMING POLYMERIC ARTICLES HAVING CONTINUOUS SUPPORT STRUCTURES

(75) Inventors: DAVID A. OKONSKI, Lake Orion, MI (US); Pablo D. Zavattieri, Ann Arbor, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/769,763

(22) Filed: Jun. 28, 2007

Related U.S. Application Data
(60) Provisional application No. 60/820,661, filed on Jul. 28, 2006.

(51) Int. Cl. B29C 47/02

(52) U.S. Cl. 264/148; 264/171.11; 264/171.13

(57) ABSTRACT

A method of making a polymeric article includes embedding a continuous support structure into a polymeric material to form a reinforced sheet, and over-molding the reinforced sheet to form the polymeric article.

### CROSS REFERENCE TO RELATED APPLICATION

This application claims the benefit of U.S. Provisional Patent Application No. 60/820,661 filed Jul. 28, 2006, and which is hereby incorporated by reference in its entirety.

### BACKGROUND

The present disclosure relates to methods of disposing a continuous support structure into a polymeric matrix to form a polymeric article and more particularly, to methods of disposing an active material continuous support structure into a polymeric matrix to form an actuatable polymeric article.

Polymeric (plastic) articles are sometimes reinforced with discontinuous support structures such as chopped-fiber and the like. Presently, research is being conducted around various uses of both active and non-active materials in the form of a continuous wire/fiber. For example, continuous support structures including an active material can be useful in making actuatable articles, while continuous support structures including a non-active material can be useful in applications where the local strength or stiffness must be precisely controlled. In the making of any of these articles, it is desirable to have the continuous support structures disposed in a fixed position (e.g., parallel) relative to one another within the polymeric matrix.

One method of disposing the continuous support structures into the polymeric matrix includes arranging the continuous support structures in a parallel fashion to each other within an injection-molding tool. For example, the injection-molding tool is configured to hold/constrain at least two wires in a parallel fashion at a predetermined distance from the parting-line of the tool. The pressures involved with the injection-molding process, however, tend to break the wires, destroy parallelism of the wires, and/or push the wires toward the parting-line of the tool. In other words, many challenges exist for incorporating continuous support structures into a polymeric matrix such that the continuous support structures' location within the polymeric matrix is maintained during manufacturing.

Accordingly, a continual need exits for improved methods of disposing a continuous support structure, such as wire, within a polymeric matrix to form a polymeric article where at least the location of the continuous support structure within the polymeric matrix can be maintained during manufacturing.

### BRIEF SUMMARY

Disclosed herein are methods of disposing continuous support structures into a polymeric matrix to form a polymeric article.

In one embodiment, a method of making a polymeric article includes embedding a first continuous support structure into a thermoplastic sheet to form a reinforced sheet, and over-molding the reinforced sheet to form the polymeric article.

In another embodiment, a method of making a polymeric article includes extruding a thermoplastic material to form a thermoplastic sheet; feeding a first continuous support structure, a second continuous support structure, and the thermoplastic sheet to at least two calendering rolls; embedding the first continuous support structure and the second continuous support structure into the thermoplastic sheet to form a reinforced sheet; cutting the reinforced sheet into segments; disposing a segment of the reinforced sheet into an injection-molding tool; and introducing a thermoplastic or a thermoset material into the injection-molding tool to over-mold the reinforced sheet.

In yet another embodiment, a method of making a polymeric article includes unrolling a thermoplastic sheet material from a roll; heating the thermoplastic sheet to a temperature sufficient to soften the thermoplastic sheet; feeding the thermoplastic sheet, a first continuous support structure, and a second continuous support structure to at least two calendering rolls; embedding the first continuous support structure and the second continuous support structure into the thermoplastic sheet using at least two calendering rolls to form a reinforced sheet; and over-molding the reinforced sheet to form the polymeric article.

The above described and other features are exemplified by the following figures and detailed description.

### BRIEF DESCRIPTION OF THE DRAWINGS

Referring now to the figures, which are exemplary embodiments and wherein like elements are numbered alike:

FIG. 1 is a schematic illustration of a process of embedding continuous support structures within a thermoplastic sheet;

FIG. 2 is a top view of the thermoplastic sheet of FIG. 1 with the continuous support structures embedded therein;

FIG. 3 is a cross sectional view of the thermoplastic sheet of FIG. 1 with continuous support structures embedded therein;

FIG. 4 is a cross sectional view of another embodiment of a thermoplastic sheet having continuous support structures embedded on opposite surfaces thereof; and

FIG. 5 is a cross sectional view of an injection-molding tool with a thermoplastic sheet having a continuous support structure embedded therein disposed in the injection-molding tool.

### DETAILED DESCRIPTION

Disclosed herein are methods of making polymeric (plastic) parts/articles having active or non-active material continuous support structures. As will be discussed in greater detail, the method of making the plastic parts includes embedding the continuous support structure into a polymeric (e.g., a thermoplastic) sheet and then over-molding the sheet. By first embedding the continuous support structure into the polymeric sheet the location of the continuous support structure within the plastic article is advantageously maintained within three-dimension space during the injection-molding process.

Active materials are defined herein as those materials that selectively exhibit a change in a fundamental material property such as stiffness and/or dimension when subjected to an applied field. Suitable active materials include, without limitation, shape memory alloys (SMA), ferromagnetic SMAs (FSMA), and shape memory polymers (SMP). A second class of active materials can be considered as those that exhibit a change in at least one attribute when subjected to an applied field, but revert back to their original state upon removal of the applied field. Active materials in this category include, but are not limited to, piezoelectric materials, electroactive polymers (EAP), two-way trained shape memory alloys, composites of one or more of the foregoing materials with non-active materials, combinations comprising at least one of the foregoing materials, and the like. Depending on the particular active material, an activation signal can take the form of, without limitation, an electric current, a temperature change, a magnetic field, a mechanical loading or stressing, or the like.

The term “parallel” as used herein in relation to various embodiments refers to at least two support structures disposed a distance apart. For each point of an axis of a first of these support structures, a related point of an axis of a second support structure can be defined, which point is the crossing point of the axis of the second support structure with the plane through the point of the axis of the first support structure and being perpendicular to the direction of the axis of the first support structure at this point. Completely parallel refers to a difference in direction of axis of the at least two support structures that is 0°. However, embodiments are envisioned where the two support structures are substantially parallel to one another. The term “parallel” is therefore inclusive of differences in direction of the axis of the at least two support structures is less than or equal to 15°, specifically less than or equal to 10°, an even more specifically less than or equal to 5°.

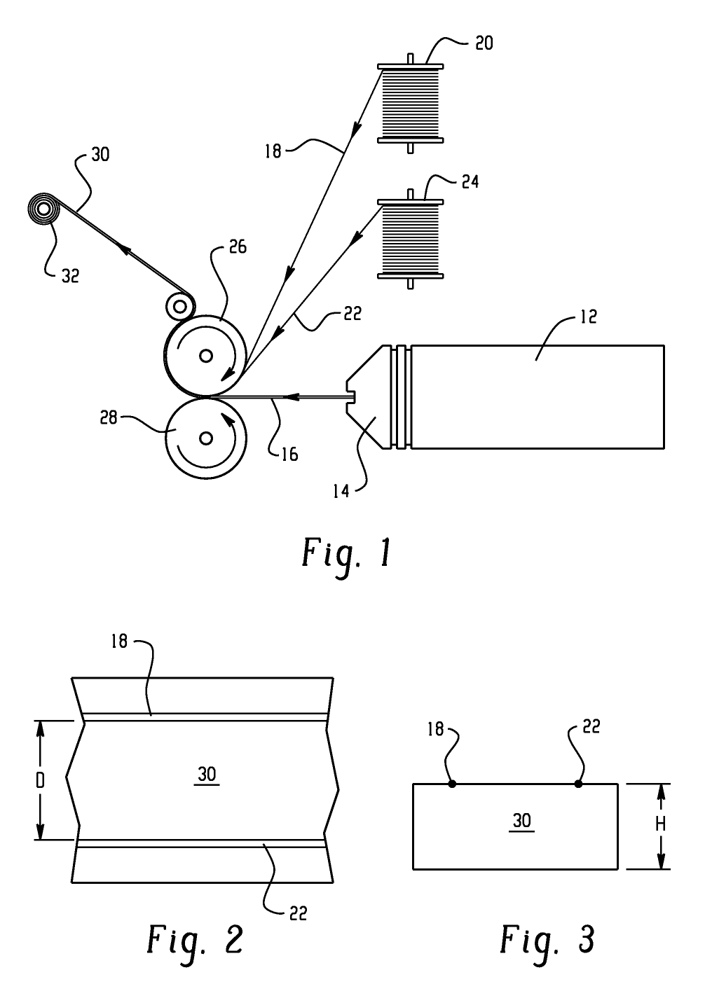

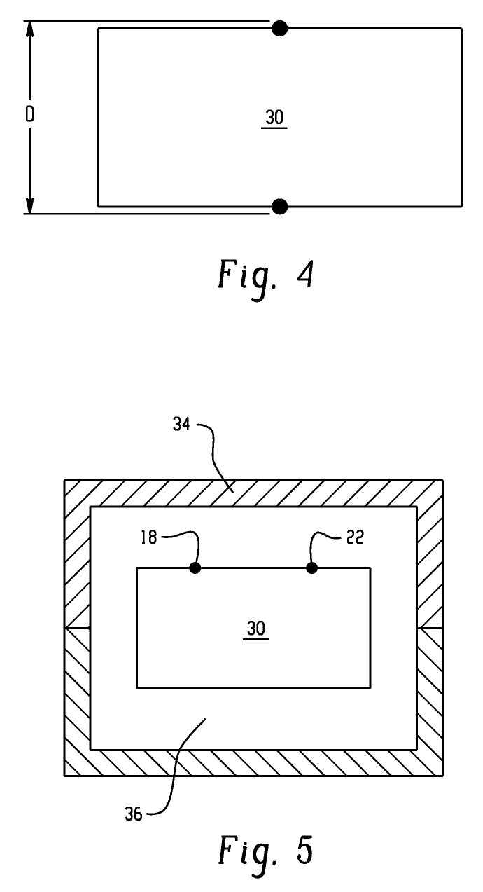

Referring now to FIGS. 1-4, a schematic illustration of a process of embedding continuous support structures within a thermoplastic sheet is illustrated. In this embodiment, a thermoplastic material is extruded from an extruder 12 via a sheet die 14 to form a thermoplastic sheet 16. The type of thermoplastic material varies depending on the desired application. Examples of suitable thermoplastic materials include, but are not limited to, polypropylene, polyethylene, polyamide, polyester, polystyrene, polyvinyl chloride, acetal, acrylic, polycarbonate, polyphenylene oxide, polyurethane, polysulfone, and other like thermoplastic polymers including, but not limited to, thermoplastic vulcanizates. In various embodiments, the sheet die 14 can optionally be a multi-sheet die such that the thermoplastic sheet 16 comprises multiple layers. These layers can comprise the same or different thermoplastic materials from each other. If differing thermoplastic layers are employed, the thermoplastic materials are selected to be compatible with the other thermoplastic layers.

A first support structure in the form of a first wire 18 is unwound from a first spool 20, and a second support structure in the form of a second wire 22 is unwound from a second spool 24. The first wire 18 and the second wire 22 each comprise either an active or non-active material. Exemplary active materials are discussed in much greater detail below. Examples of non-active material include, but are not limited to, metals (e.g., copper, aluminum, and the like) and metal alloys (e.g., copper based alloys). In various embodiments, the support structures can take other suitable forms, which include, but are not limited to, fibers, ribbons, and the like. The thermoplastic sheet 16, the first wire 18, and the second wire 22 are jointly fed to calendering rolls 26 and 28 to form a material bank.

Optional additional wires can also be feed to the calendering rolls 26 and 28. In one embodiment, a group of wires/fibers can be placed in parallel or with a certain angle. In another embodiment, a group of parallel wires/fibers can be placed at an angle with respect to the sheet direction, making a zigzag pattern. Furthermore, groups of zigzagging parallel wires/fibers with different angles (with respect to the sheet direction) can be placed in the polymeric sheet. In making this zigzag arrangement, a moving support structure is employed to guide the wires/fibers. In another embodiment, a “mesh” (e.g., braided wires/fibers) made of active or non-active wires/fibers can be fed to the calendaring rolls.

In one embodiment, the first wire 18 and the second wire 22 are fed in such a manner so as to maintain a separation distance between them, illustrated as distance “D”, which varies depending on the desired application. However, when optional additional wires are employed, the additional wires can also be fed in such a manner so as to maintain a separation distance between each of the wires or alternatively some wires can be grouped together to create a densified region relative to other additional wires. In one embodiment, the first wire 18 and the second wire 22 are fed in such a manner that they are parallel to each other. In other embodiments, the first wire 18 and the second wire 22 are also parallel to the direction of the draw. In one embodiment, the first wire 18 and the second wire 22 are disposed on a same side of the thermoplastic sheet 16. In yet other embodiments, the first wire 18 and the second wire 22 are disposed on opposite sides of the thermoplastic sheet 16. When optional additional wires are employed the wires can be arranged in parallel to one another in various combinations of the same side or opposite sides of the thermoplastic sheet 16. Furthermore, if a multi-sheet die is used with different thermoplastic layers, different groups of wires/fibers can be placed between layers as well.

While processing parameters vary depending on the materials employed, the draw rate is maintained at a level such that the first wire 18 and the second wire 22 each maintain the desired strain and will allow the wires to perform in the desired manner. In various embodiments using an active material, if the martensite to austenite phase transformation occurs in the wire, extra rolls may be placed to keep different stresses and, therefore, maintain the desired strain. The feed temperature of the thermoplastic sheet 16 is as close as possible to the melting point of the thermoplastic materials of thermoplastic sheet 16, but not so close as to create excessive sag in the thermoplastic sheet 16. The feed temperature is a variable of the materials employed, as well as the thickness of the thermoplastic sheet 16, which is illustrated as “H”.

Adjusting the pressure exerted by the calendering rolls 26 and 28 controls the penetration depth of first wire 18 and second wire 22 into a surface of the thermoplastic sheet 16. In one embodiment, each of the first wire 18 and second wire 22 are embedded in the same surface of the thermoplastic sheet 16. However, embodiments are envisioned where at least one of the first wire 18 and the second wire 22 are completely disposed within the thermoplastic sheet 16. For example, at least one of the first wire 18 or second wire 22 can be buried within the thermoplastic sheet 16 by feeding it through the sheet die 14 on the extruder 12. With regard to the temperature of the calendering rolls 26 and 28, it is dictated by the material properties of the first wire 18 and second wire 22. The resulting thermoplastic sheet with embedded wires is hereinafter referred to as reinforced sheet 30. The reinforced sheet 30 can be rolled onto a take-up roll 32, which allows for ease in storing the reinforced sheet 30 for subsequent processing. Furthermore, it is noted that the size of the calendering rolls, material of the rolls, number of rolls, the film wrap around the rolls, and the like may vary.

Having formed the reinforced sheet 30, the reinforced sheet 30 can be cut to a size so as to fit within a cavity of an injection-molding tool. Referring now to FIG. 5, a cross sectional view of an injection-molding tool 34 is illustrated. During operation, the cut reinforced sheet 30 is disposed within the injection-molding tool 34 and a thermoplastic or thermoset material is introduced into the injection-molding tool 34. The injection-molding tool 34 has an interior cavity 36 that corresponds to the final shape of the desired article. The thermoplastic or thermoset material is selected to be compatible with the reinforced sheet. Suitable thermoplastic materials include, but are not limited to, thermoplastic polyolefins, thermoplastic vulcanizates, and combinations comprising at least one of the foregoing. In one embodiment, suitable thermoplastic or thermoset materials include, but are not limited to, polymers such as polyalkenes (e.g., polyethylene, polypropylene, and the like), polycarbonates, polyesters, polycarbonates, polyacrylates, polybutylenes, polystyrenes, polyacrylonitriles, polyvinylchlorides, acetals, polyamides (e.g., nylons), polysulfones, polyurethanes, acrylates, and polyphenylene oxide. After a sufficient period of time for the thermoplastic or thermoset to harden, the finished product can be removed from the injection-molding tool.

It is to be understood that in various other embodiments, the thermoplastic sheet 16 can be extruded as discussed above, but not directly fed to calendering rolls 26 and 28. In other words, the desired thermoplastic sheet 16 can be rolled, stored, and later unrolled and fed to calendering rolls 26 and 28. In this example, the temperature of the calendering rolls is sufficient to soften the thermoplastic sheet material such that the first wire 18 and the second wire 22 can be embedded in the thermoplastic sheet 16. This embodiment advantageously allows the first wire 18 and second wire 22 to be added without having to extrude the thermoplastic sheet 16 on the same processing line, which allows flexibility in the source of the thermoplastic sheet material.

As mentioned above, the reinforced sheet 30 includes first wire 18 and second wire 22, each of which comprises an active or non-active material. In one embodiment, the active material includes shape memory alloys (SMA). The shape memory alloys exist in several different temperature-dependent phases. The most commonly utilized of these phases are the so-called martensite and austenite phases. In the following discussion, the martensite phase generally refers to the more deformable, lower temperature phase, whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (As). The temperature at which this phenomenon is complete is called the austenite finish temperature (Af). When the shape memory alloy is in the austenite phase and is cooled, it begins to change into the martensite phase, and the temperature at which this phenomenon starts is referred to as the martensite start temperature (Ms). The temperature at which austenite finishes transforming to martensite is called the martensite finish temperature (Mf). Generally, the shape memory alloys are softer and more easily deformable in their martensitic phase and are harder, stiffer, and/or more rigid in the austenitic phase. In view of the foregoing, a suitable activation signal for use with shape memory alloys is a thermal activation signal having a magnitude to cause transformations between the martensite and austenite phases.

Shape memory alloys can exhibit a one-way shape memory effect, an intrinsic two-way effect, or an extrinsic two-way shape memory effect depending on the alloy composition and processing history. Annealed shape memory alloys typically only exhibit the one-way shape memory effect. Sufficient heating subsequent to low-temperature deformation of the shape memory material will induce the martensite to austenite type transition, and the material will recover the original, annealed shape. Hence, one-way shape memory effects are only observed upon heating. Active materials comprising shape memory alloy compositions that exhibit one-way memory effects do not automatically reform, and will generally require an external mechanical force to reform the shape.

The temperature at which the shape memory alloy remembers its high temperature form when heated can be adjusted by slight changes in the composition of the alloy and through heat treatment. In nickel-titanium shape memory alloys, for example, it can be changed from above about 130° C. to below about −100° C. The shape recovery process occurs over a range of just a few to several degrees and the start or finish of the transformation can be controlled to within a degree or two depending on the desired application and alloy composition. The mechanical properties of the shape memory alloy vary greatly over the temperature range spanning their transformation, typically providing the part with shape memory effects, superelastic effects, and high damping capacity.

Shape memory alloys exhibit a modulus increase up to 2.5 times and a dimensional change of up to 8% (depending on the amount of pre-strain) when heated above their so-called martensite to austenite phase transition temperature. Suitable shape memory alloy materials include, but are not limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order so long as the alloy composition exhibits a shape memory effect, e.g., change in shape orientation, changes in yield strength, and/or flexural modulus properties, damping capacity, superelasticity, and the like. Selection of a suitable shape memory alloy composition depends on the temperature range where the component will operate.

In one embodiment, the active material includes ferromagnetic SMAs. Generally, ferromagnetic SMAs exhibit rapid dimensional changes of up to several percent in response to (and proportional to the strength of) an applied magnetic field.

In one embodiment, the active material includes shape memory polymers (SMP). Generally, shape memory polymers (SMP) exhibit a dramatic drop in modulus when heated above the glass transition temperature of that of one of their constituents, usually two constituents, that has a lower glass transition temperature. If loading/deformation is maintained while the temperature is dropped, the deformed shape will be set in the SMP until it is reheated while under no load under which condition it will return to its as-molded shape.

Most SMPs exhibit a “one-way” effect, wherein the SMP exhibits one permanent shape. Generally, SMPs are phase segregated co-polymers comprising at least two different units, which may be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment may be crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n−1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be shaped. A permanent shape for the SMP can be set or memorized by subsequently cooling the SMP below that temperature. As used herein, the terms “original shape”, “previously defined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it may be possible to demonstrate multiple permanent shapes. Similarly using a layered or composite approach, a combination of multiple SMPs will demonstrate transitions between multiple temporary and permanent shapes.

For SMPs with only two segments, the temporary shape of the SMP is set at the first transition temperature, followed by cooling of the SMP, while under load, to lock in the temporary shape. The temporary shape is maintained as long as the SMP remains below the first transition temperature. The permanent shape is regained when the SMP is once again brought above the first transition temperature. Repeating the heating, shaping, and cooling steps can repeatedly reset the temporary shape.

In other embodiments, some shape memory polymer compositions can be prepared to exhibit a “two-way” effect, wherein the SMP exhibits two permanent shapes. These systems include at least two polymer components. For example, one component could be a first cross-linked polymer while the other component is a different cross-linked polymer. The components are combined by layer techniques, or are interpenetrating networks, wherein the two polymer components are cross-linked, but not to each other. By changing the temperature, the shape memory polymer changes its shape in the direction of a first permanent shape or a second permanent shape. Each of the permanent shapes belongs to one component of the SMP. The temperature dependence of the overall shape is caused by the fact that the mechanical properties of one component (“component A”) are almost independent from the temperature in the temperature interval of interest. The mechanical properties of the other component (“component B”) are temperature dependent in the temperature interval of interest. In one embodiment, component B becomes stronger at low temperatures compared to component A, while component A is stronger at high temperatures and determines the actual shape. A two-way memory device can be prepared by setting the permanent shape of component A (“first permanent shape”), deforming the device into the permanent shape of component B (“second permanent shape”), and fixing the permanent shape of component B while applying a stress.

It should be recognized by one of ordinary skill in the art that it is possible to configure SMPs in many different forms and shapes. Engineering the composition and structure of the polymer itself can allow for the choice of a particular temperature for a desired application. For example, depending on the particular application, the last transition temperature may be about 0° C. to about 300° C. or above. A temperature for shape recovery (i.e., a soft segment thermal transition temperature) may be greater than or equal to about −30° C. Another temperature for shape recovery may be greater than or equal to about 20° C. Another temperature for shape recovery may be greater than or equal to about 70° C. Another temperature for shape recovery may be less than or equal to about 250° C. Yet another temperature for shape recovery may be less than or equal to about 200° C. Finally, another temperature for shape recovery may be less than or equal to about 180° C.

Suitable polymers for use in the SMPs include thermoplastics, thermosets, interpenetrating networks, semi-interpenetrating networks, or mixed networks of polymers. The polymers can be a single polymer or a blend of polymers. The polymers can be linear or branched thermoplastic elastomers with side chains or dendritic structural elements. Suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysitoxanes, polyurethanes, polyethers, polyether amides, polyether esters, polystyrene, polypropylene, polyvinyl phenol, polyvinylpyrrolidone, chlorinated polybutylene, poly(octadecyl vinyl ether) ethylene vinyl acetate, polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsesquioxane), polyvinyl chloride, urethane/butadiene copolymers, polyurethane block copolymers, styrene-butadiene-styrene block copolymers, and the like, and combinations comprising at least one of the foregoing polymer components. Examples of suitable polyacrylates include poly(methyl methacrylate), poly(ethyl methacrylate), ply(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate). The polymer(s) used to form the various segments in the SMPs described above are either commercially available or can be synthesized using routine chemistry. Those of ordinary skill in the art can readily prepare the polymers using known chemistry and processing techniques without undue experimentation.

In one embodiment, the active material includes piezoelectric materials, which can be uni-morph or bimorph. Generally, piezoelectric materials exhibit small changes in dimensions when subjected to an applied voltage. Their response is proportional to the strength of the applied field and is quite fast (being capable of easily reaching the thousand hertz range). Because their dimensional change is small (<0.1%), to dramatically increase the magnitude of dimensional change they are usually used in the form of piezoelectric uni-morph and bi-morph flat patch actuators that are constructed so as to bow into a concave or convex shape upon application of a relatively small voltage. Moreover, piezoelectric patches return automatically to their original geometry once the field is removed. Another advantage of the piezoelectric materials is their rapid actuation times, which are typically on the order of milliseconds.

Suitable piezoelectric materials include, but are not limited to, inorganic compounds, organic compounds, and metals. With regard to organic materials, all of the polymeric materials with non-centrosymmetric structure and large dipole moment group(s) on the main chain or on the side-chain, or on both chains within the molecules, can be used as suitable candidates for the piezoelectric material. Exemplary polymers include, for example, but are not limited to, poly(sodium 4-styrenesulfonate), poly (poly(vinylamine) backbone azo chromophore), and their derivatives; polyfluorocarbons, including polyvinylidenefluoride, its co-polymer vinylidene fluoride (“VDF”), co-trifluoroethylene, and their derivatives; polychlorocarbons, including poly(vinyl chloride), polyvinylidene chloride, and their derivatives; polyacrylonitriles, and their derivatives; polycarboxylic acids, including poly(methacrylic acid), and their derivatives; polyureas, and their derivatives; polyurethanes, and their derivatives; bio-molecules such as poly-L-lactic acids and their derivatives, and cell membrane proteins, as well as phosphate bio-molecules such as phosphodilipids; polyanilines and their derivatives, and all of the derivatives of tetramines; polyamides including aromatic polyamides and polyimides, including Kapton and polyetherimide, and their derivatives; all of the membrane polymers; poly(N-vinyl pyrrolidone) (PVP) homopolymer, and its derivatives, and random PVP-co-vinyl acetate copolymers; and all of the aromatic polymers with dipole moment groups in the main-chain or side-chains, or in both the main-chain and the side-chains, and mixtures thereof.

Piezoelectric material can also comprise metals selected from the group consisting of lead, antimony, manganese, tantalum, zirconium, niobium, lanthanum, platinum, palladium, nickel, tungsten, aluminum, strontium, titanium, barium, calcium, chromium, silver, iron, silicon, copper, alloys comprising at least one of the foregoing metals, and oxides comprising at least one of the foregoing metals. Suitable metal oxides include SiO₂, Al₂O₃, ZrO₂, TiO₂, SrTiO₃, PbTiO₃, BaTiO₃, FeO₃, Fe₃O₄, ZnO, and mixtures thereof and Group VIA and IIB compounds, such as CdSe, CdS, GaAs, AgCaSe₂, ZnSe, GaP, InP, ZnS, and mixtures thereof. Preferably, the piezoelectric material is selected from the group consisting of polyvinylidene fluoride, lead zirconate titanate, and barium titanate, and mixtures thereof.

In one embodiment, the active material includes electroactive polymers (EAP). EAP's are essentially a laminate consisting of a pair of electrodes with an intermediate layer of low elastic modulus dielectric material. Applying a potential between the electrodes squeezes the intermediate layer causing it to expand in plane. They exhibit a response proportional to the applied field and can be actuated at high frequencies. EAP patch vibrators have been demonstrated (by the company Artificial Muscle Inc. at 2005 SPIE Conference).

Electroactive polymers include those polymeric materials that exhibit piezoelectric, pyroelectric, or electrostrictive properties in response to electrical or mechanical fields. In one embodiment, the electroactive polymer comprises an electrostrictive-grafted elastomer with a piezoelectric poly(vinylidene fluoride-trifluoroethylene) copolymer. This combination has the ability to produce a varied amount of ferroelectric-electrostrictive molecular composite systems.

Materials suitable for use as an electroactive polymer may include any substantially insulating polymer or rubber (or combination thereof) that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example.

Materials used as an electroactive polymer may be selected based on one or more material properties such as a high electrical breakdown strength, a low modulus of elasticity (for large or small deformations), a high dielectric constant, and the like. In one embodiment, the polymer is selected such that it has an elastic modulus at most about 100 MPa. In another embodiment, the polymer is selected such that it has a maximum actuation pressure between about 0.05 MPa and about 10 MPa, and preferably between about 0.3 MPa and about 3 MPa. In another embodiment, the polymer is selected such that it has a dielectric constant between about 2 and about 20, and preferably between about 2.5 and about 12. The present disclosure is not intended to be limited to these ranges. Ideally, materials with a higher dielectric constant than the ranges given above would be desirable if the materials had both a high dielectric constant and a high dielectric strength.

As electroactive polymers may deflect at high strains, electrodes attached to the polymers should also deflect without compromising mechanical or electrical performance. Generally, electrodes suitable for use may be of any shape and material provided that they are able to supply a suitable voltage to, or receive a suitable voltage from, an electroactive polymer. The voltage may be either constant or varying over time. In one embodiment, the electrodes adhere to a surface of the polymer. Electrodes adhering to the polymer are preferably compliant and conform to the changing shape of the polymer. Correspondingly, the present disclosure may include compliant electrodes that conform to the shape of an electroactive polymer to which they are attached. The electrodes may be only applied to a portion of an electroactive polymer and define an active area according to their geometry.

Materials used for electrodes of the present disclosure may vary. Suitable materials used in an electrode may include graphite, carbon black, thin metals including silver and gold, ionically or electronically conductive polymers, and the like. It is understood that certain electrode materials may work well with particular polymers and may not work as well for others. By way of example, carbon fibrils work well with acrylic elastomer polymers while not as well with silicone polymers.

Advantageously, the methods disclosed herein allow a support structure to be maintained within three-dimension space during the manufacturing process, which allows for precise placement of the support structure in the final product. Precise placement of the active material support structure in the final product in turn allows for greater control of actuation in the final product.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A method of making a polymeric article comprising:
embedding a first continuous support structure into a polymeric material to form a reinforced sheet, and
over-molding the reinforced sheet to form the polymeric article.

2. The method of claim 1, wherein the first continuous support structure is embedded within a surface of the polymeric material.

3. The method of claim 1, wherein the first continuous support structure is completely embedded within the polymeric material.

4. The method of claim 1, further comprising embedding a second continuous support structure into the polymeric material.

5. The method of claim 4, wherein the first continuous support structure and the second continuous support structure are embedded such that the first continuous support structure and the second continuous support structure are parallel to each other.

6. The method of claim 1, wherein the first continuous support structure is embedded in a first surface of the polymeric material; and further comprising embedding a second continuous support structure into a second surface of the polymeric material that is opposite the first surface.

7. The method of claim 1, wherein embedding the first continuous support structure into the polymeric material further comprises passing the first continuous support structure through a die of an extruder such that the first continuous support structure is completely embedded within the polymeric material.

8. The method of claim 1, further comprising embedding additional continuous support structures into the polymeric material, wherein the first continuous support and the additional continuous supports are disposed in the polymeric material in a zigzag pattern, as a mesh, or a combination the foregoing.

9. The method of claim 1, wherein the embedding of the first continuous support structure further comprises disposing the first continuous support structure between the polymeric material and a second polymeric material such that the reinforced sheet comprises multi-layers.

10. A method of making a polymeric article comprising:
extruding a thermoplastic material to form a thermoplastic sheet;
feeding a first continuous support structure, a second continuous support structure, and the thermoplastic sheet to at least two calendering rolls;
embedding the first continuous support structure and the second continuous support structure into the thermoplastic sheet to form a reinforced sheet;
cutting the reinforced sheet into segments;
disposing a segment of the reinforced sheet into an injection-molding tool; and
introducing a thermoplastic or a thermoset material into the injection-molding tool to over-mold the reinforced sheet.

11. The method of claim 10, wherein the first continuous support structure and the second continuous support structure are embedded into a same surface of the thermoplastic sheet.

12. The method of claim 10, wherein the first continuous support structure is embedded into a first surface of the thermoplastic sheet and the second continuous support structure is embedded into a second surface of the thermoplastic sheet that is opposite the first surface.

13. The method of claim 10, wherein the first continuous support structure and the second continuous support structure are embedded such that the first continuous support structure and the second continuous support structure are parallel to each other.

14. The method of claim 10, wherein each of the first and the second continuous support structure is completely embedded within the thermoplastic sheet.

15. The method of claim 10, wherein embedding the first and the second continuous support structure into the thermoplastic sheet further comprises passing the first and the second continuous support structure through a die of an extruder such that the first and the second continuous support structures are completely embedded within the thermoplastic sheet.

16. A method of making a polymeric article comprising:
unrolling a thermoplastic sheet material from a roll;
heating the thermoplastic sheet to a temperature sufficient to soften the thermoplastic sheet;
feeding the thermoplastic sheet, a first continuous support structure, and a second continuous support structure to at least two calendering rolls;
embedding the first continuous support structure and the second continuous support structure into the thermoplastic sheet using the at least two calendering rolls to form a reinforced sheet; and
over-molding the reinforced sheet to form the polymeric article.

17. The method of claim 16, wherein the first continuous support structure and the second continuous support structure are embedded into a same surface of the thermoplastic sheet.

18. The method of claim 16, wherein the first continuous support structure is embedded into a first surface of the thermoplastic sheet and the second support structure is embedded into a second surface of the thermoplastic sheet that is opposite the first surface.

19. The method of claim 16, wherein the first continuous support structure and the second continuous support structure are embedded such that the first continuous support structure and the second continuous support structure are parallel to each other.

20. The method of claim 16, wherein each of the first continuous support structure and the second continuous support structure are completely embedded within the thermoplastic sheet.
